(19) United States
(12) Patent Application Publication
(10) Pub. No.: US 2018/0363820 A1
(43) Pub. Date: Dec. 20, 2018

(54) CAMLOCK FITTING SAFETY DEVICE AND METHOD

(71) Applicants: Mark Tracy Lane, Sorrento (CA); Ben Lloyd Taarnes, Sorrento (CA)

(72) Inventors: Mark Tracy Lane, Sorrento (CA); Ben Lloyd Taarnes, Sorrento (CA)

(21) Appl. No.: 15/624,630

(22) Filed: Jun. 15, 2017

(51) Int. Cl. F16L 37/084

(52) U.S. Cl. CPC F16L 37/0841

(57) ABSTRACT

A safety attachment includes a pipe body, a first piston housing including a first piston chamber including a first opening, a first fluid port, a first piston including a first pin and a first O-ring, and a second piston housing including a second piston chamber including a second opening, a second fluid port, a second piston including a second pin and a second O-ring. The safety attachment is useful for preventing the camlock fitting from becoming inadvertently separated from a hose.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of cam lock fittings and more specifically relates to a safety attachment for a cam lock fitting.

### 2. Description of Related Art

Cam and groove couplings and hose fittings are used in the liquid delivery industry and in many liquid and dry bulk transport applications. It is a quick connect coupling usually used in industries as a hose connection to avoid leakage. Cam arms at the end of each lever on the female end align with a circumferential groove on the male end. When the levers are rotated to the locked position, they pull the male end into the female socket, creating a tight seal up against a gasket. The arms lock into position using an over-center arrangement. Cam arms are subject to wear and abuse during use. Hoses used for transport and delivery of liquids are often dragged on the ground. The fittings on the end of the hose are dropped and dragged across hard pavement surfaces. The arms become rough and bent and the split rings will bend and develop rough edges and burrs. The cam arms on the female fitting are also subject to vibration during use. Pulses transmitted through the liquid from the pump can vibrate a cam arm open causing the coupling to separate and a spill will result. This can be not only time consuming and expensive, but dangerous for the operator. Thus, a suitable solution is desired.

U.S. Pat. No. 8,123,256 to Jeffrey Hartman relates to a safety lock for cam lock fitting. The described safety lock for cam lock fitting includes a method and apparatus for a safety lock for a cam lock fitting contained in a housing mounted onto the outside of the cam lock fitting so that the housing is in close proximity to the cam lever so that when the cam lock fitting is pressurized and the lever is in a down position a pin can extend from the housing so as to secure the lever in a downward position and therefore prevent operation or release of the male and the female portions of the fitting. The housing has a piston therein which moves along a bore so that the piston can be moved by the pressure of fluid contained inside the cam lock fitting so that in a low pressure condition the pin is retracted so that the cam lever can then be raised. The pin is connected to the piston with an 1-shaped arm which has a pivot point so that when the piston is in the down position the pin is in a retracted position. When the coupling is pressurized the piston moves upwardly along the bore so that the pin is extended over the arm in order to prevent the arm from being moved to the open position and thereby allowing the male end to be removed from the female end of the cam lock fitting.

### BRIEF SUMMARY OF THE INVENTION

In view of the foregoing disadvantages inherent in the known cam lock fittings art, the present disclosure provides a novel camlock fitting safety device and method. The general purpose of the present disclosure, which will be described subsequently in greater detail, is to provide a safety attachment for a camlock fitting so as to prevent the camlock fitting from becoming inadvertently separated from a hose.

A safety attachment for a camlock fitting is disclosed herein. The safety attachment for a camlock fitting includes a pipe body which may include an internal volume defined by a left side, a right side opposite the left side, a first end, and a second end opposite the first end; the first end being configured to releasably attach to a fluid vessel; the second end being configured to releasably attach to the camlock fitting. Further, a first piston housing may be fixedly attached to the left side of the pipe body; the first piston housing may include a first piston chamber which may include a first opening at one end, and a first fluid port at the opposite end; the first fluid port connecting the first piston chamber to the internal volume of the pipe body and the first fluid port being configured to allow free passage of a pressurized fluid from the fluid vessel therebetween.

In addition, a first piston may be housed within the first piston chamber; the first piston may include a first pin and a first O-ring. The first pin is moveable from a stowed state to an extended state. The first O-ring may be wrapped around an outer diameter of the first piston and configured to prevent the pressurized fluid from escaping through the first opening and a first retraction means configured to move the first pin into the stowed state.

Similarly, a second piston housing may be fixedly attached to the right side of the pipe body. The second piston housing may include a second piston chamber which may include a second opening at one end, and a second fluid port at the opposite end; the second fluid port connecting the second piston chamber to the internal volume of the pipe body and the second fluid port being configured to allow free passage of the pressurized fluid from the fluid vessel therebetween. Further still, a second piston may be housed within the second piston chamber; the second piston may include a second pin and a second O-ring. The second pin is moveable from the stowed state to the extended state; the second O-ring wrapped around an outer diameter of the second piston and configured to prevent the pressurized fluid from escaping through the second opening and a second retraction means configured to move the second pin into the stowed state.

The cam arms may be located directly adjacent the first opening and the second opening respectively, such that when first pin and the second pin are in the extended state, they securely lock the cam arms in the closed-position.

A method of using a safety attachment for a camlock fitting is also disclosed herein. The method of using a safety attachment for a camlock fitting, may comprise the steps of: providing the safety attachment, (the safety attachment may include a pipe body which may have an internal volume, a left side, a right side, a first end, a second end, a first piston housing may have a first piston chamber may include a first opening and a first fluid port, a first piston may include a first pin, and a first retraction means, and a second piston housing may have a second piston chamber may include a second opening and a second fluid port, a second piston may include a second pin, and a second retraction means), attaching the second end of the pipe body to the camlock fitting, securing the cam arms of the camlock fitting in the closed-position, attaching the first end of the pipe body to a fluid vessel (the fluid vessel configured to pump a pressurized fluid through the pipe body and the camlock fitting), attaching a hose to the camlock fitting at an opposite end to the attached pipe body, pumping the pressurized fluid through the pipe body (the pressurized fluid passing through the first fluid port within the first piston chamber, and the second fluid port within the second piston chamber respectively, the pressurized fluid exerting a force on the first piston and the second piston and causing the first pin and the second pin to move from a stowed state to an extended state, the first and second pin protruding at least one inch out of the first opening and the second opening in the extended state, the extended state locking the cam arms in the closed-position), discontinuing the flow of the pressurized fluid from the fluid vessel (the first retraction means and the second retraction means exerting a force on the first piston and the second piston and causing the first pin and the second pin to move from the extended state to the stowed sate, the stowed state releasing the cam arms in the closed-position), disconnecting the first end of the pipe body from the fluid vessel, moving the cam arms of the camlock fitting from the closed-position to the open-position, and disconnecting the second end of the pipe body from the camlock fitting.

Further steps may include: providing the pipe body further including a lock at a top side of the pipe body, and locking the second end of the pipe body to the camlock fitting to further secure the safety attachment to the camlock fitting.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a camlock fitting safety device and method, constructed and operative according to the teachings of the present disclosure.

FIG. 1 is a side view of the safety attachment for a camlock fitting during an ‘in-use’ condition, according to an embodiment of the disclosure.

FIG. 2A is a side perspective view of the safety attachment for a camlock fitting illustrating a stowed state of a first pin and a second pin according to an embodiment of the present disclosure.

FIG. 2B is a side perspective view of the safety attachment for a camlock fitting illustrating an extended state of the first pin and the second pin of FIG. 2A according to an embodiment of the present disclosure.

FIG. 3 is a side perspective view of the safety attachment for a camlock fitting, illustrating a cut away view of a first piston housing and the first pin of FIG. 2A, according to an embodiment of the present disclosure.

FIG. 4A is a close-up view of the safety attachment for a camlock fitting illustrating components of a second piston housing according to an embodiment of the present disclosure.

FIG. 4B is a close-up view of the safety attachment for a camlock fitting illustrating the extended state of the second pin of FIG. 2B according to an embodiment of the present disclosure.

FIG. 5 is a flow diagram illustrating a method of use for safety attachment for a camlock fitting according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a cam lock fittings and more particularly to a camlock fitting safety device and method as used to improve a safety attachment for a camlock fitting so as to prevent the camlock fitting from becoming inadvertently separated from a hose.

Generally, the present disclosed invention may be an attachment that locks a camlock or cam and groove device so it cannot be released while under pressure. When the arms on a camlock or cam and groove device are in the closed position to hold the attached pipe, this unit may prevent the camlock from becoming released while under pressure. When fluid/pressure is put through the unit it pushes 2 pins out to make it not possible to remove the cam arms. When the pressure goes to zero or suction is used, the pins may retract allowing the cam arms to be opened and releasing the pipe.

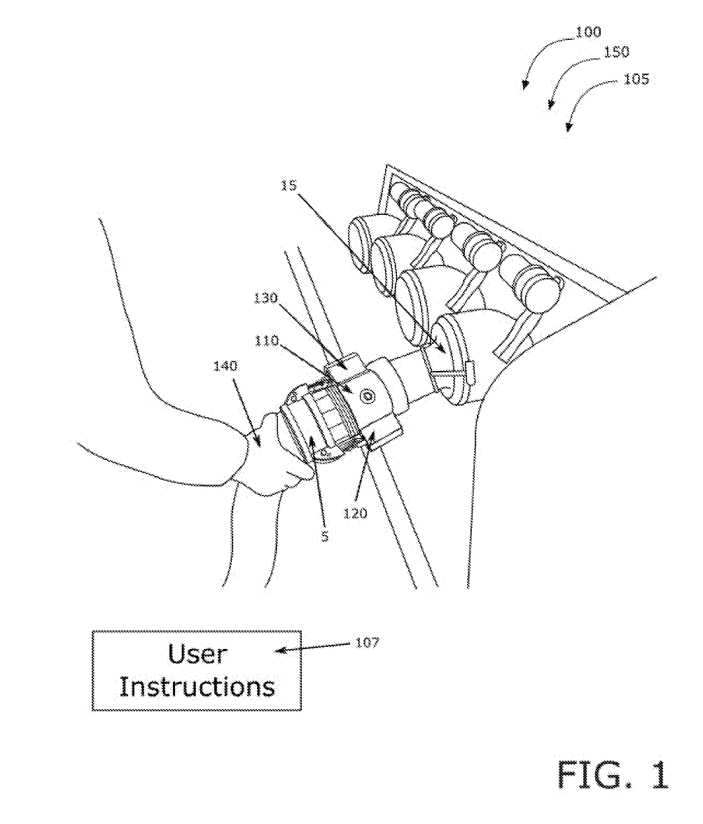

Referring now more specifically to the drawings by numerals of reference, there is shown in FIGS. 1-4B, various views of a safety attachment for a camlock fitting 100.

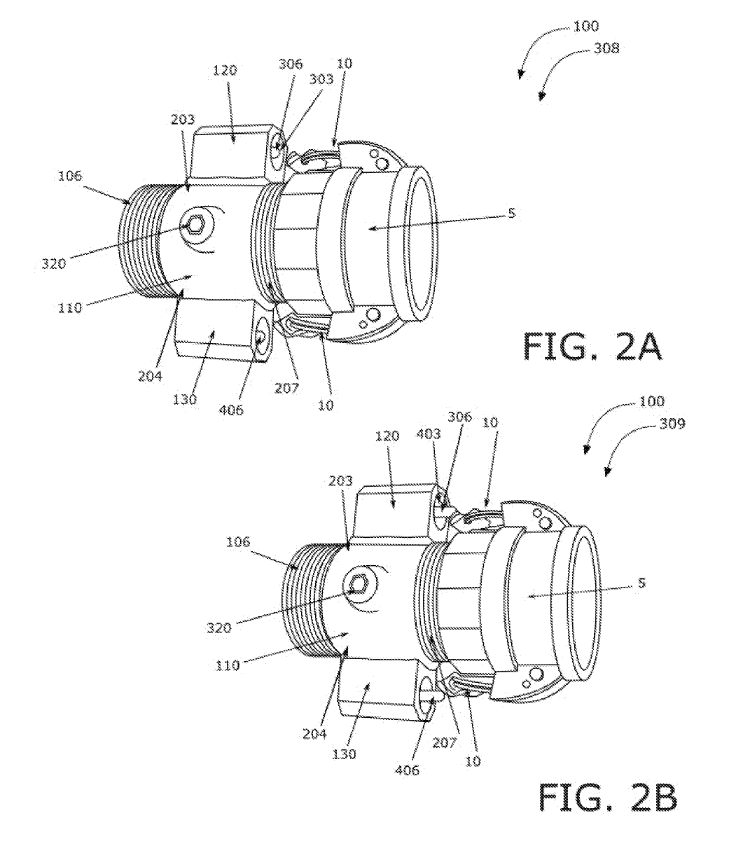

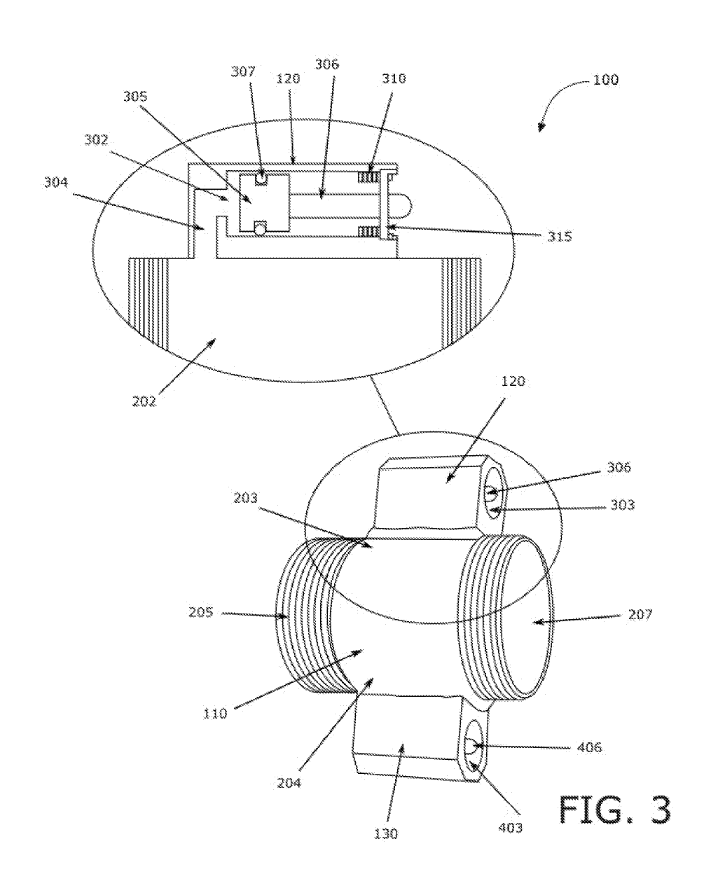

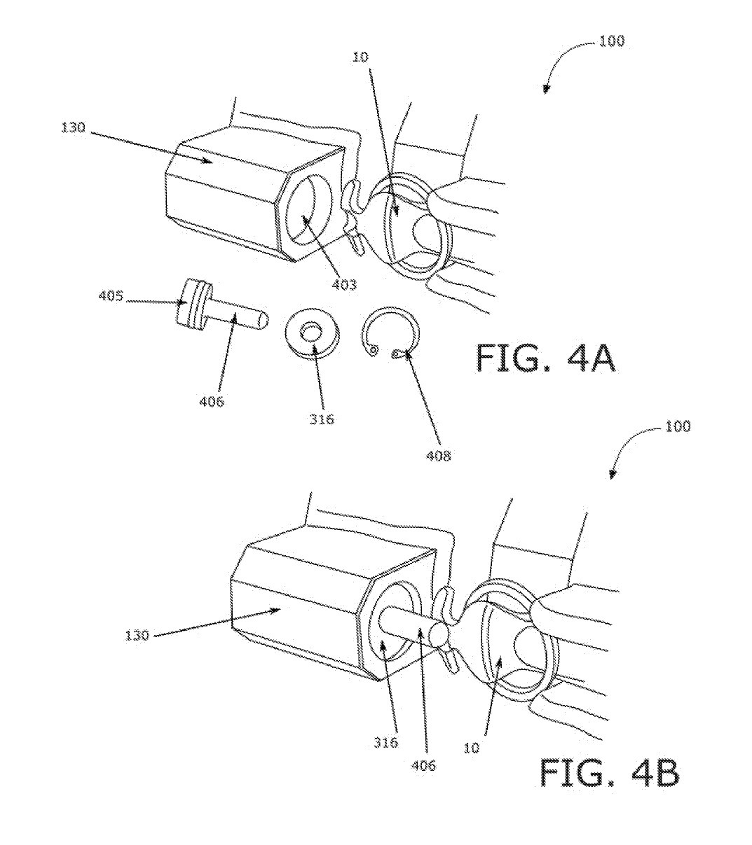

FIG. 1 shows a safety attachment for a camlock fitting (“safety attachment” 100) during an ‘in-use’ condition 50, according to an embodiment of the present disclosure. Here, the safety attachment 100 may be beneficial for use by a user 40 to prevent the camlock fitting from becoming inadvertently separated from a hose. As illustrated, the safety attachment 100 may include a pipe body 110, a first piston housing 120 including a first piston chamber 302 (FIG. 3), a first opening 303 (FIG. 2), a first piston 305 and a first pin 306 (FIG. 2), and a second piston housing 130 including a second piston chamber 402 (FIG. 4) a second opening 403 (FIG. 2), a second piston 405 (FIG. 4) and a second pin 406 (FIG. 2).

The camlock fitting 5 may include two cam arms 10 having an open-position and a closed-position. The cam arms 10 may be located directly adjacent the first opening 303 and the second opening 403 respectively, such that when first pin 306 and the second pin 406 are in an extended state 309, they securely lock the cam arms 10 in a closed-position.

According to one embodiment, the safety attachment 100 may be arranged as a kit 105. In particular, the safety attachment 100 may further include a set of instructions 107. The instructions 107 may detail functional relationships in relation to the structure of the safety attachment 100 such that the safety attachment 100 can be used, maintained, or the like, in a preferred manner.

FIG. 2A shows the safety attachment of FIG. 1, according to an embodiment of the present disclosure. Illustrated here is the safety attachment 100 attached to the camlock fitting 5 and showing the first pin 306 and the second pin 406 in a stowed sate 308. Here, the cam arms 10 of the camlock fitting 5 may be easily placed into an open-position and the camlock fitting may be removed from the safety attachment 100. As above, the safety attachment 100 may include a pipe body 110, a first piston housing 120 including a first piston chamber 302 (FIG. 3), a first opening 303, a first piston 305 (FIG. 3) and a first pin 306, and a second piston housing 130 including a second piston chamber 402 (FIG. 4), a second opening 403, a second piston 405 (FIG. 4) and a second pin 406. The pipe body 110 may include an internal volume 202 defined by a left side 203, a right side 204 opposite the left side 203, a first end 206, and a second end 207 opposite the first end 206, the first end 206 being configured to releasably attach to a fluid vessel 15, the second end 207 being configured to releasably attach to the camlock fitting 5.

In a preferred embodiment, the second end 207 of the safety attachment 100 may include a male thread. Further, the camlock fitting 5 may include a female thread configured to mate with the male thread of the second end 207. Additionally, the pipe body 110 may be substantially equal in diameter to the camlock fitting 5. This may allow for ease of mating the safety attachment 100 to the camlock fitting 5 and also to ensure there are no leaks of the pressurized fluid. As illustrated, in the preferred embodiment, the safety attachment 100 may further include a lock and a key for securely locking the attachment to the camlock fitting 5.

The first piston housing 120 may be fixedly attached to the left side 203 of the pipe body 110, the first piston housing 120 including the first piston chamber 302 (FIG. 3) including the first opening 303 at one end, and a first fluid port 304 (FIG. 3) at the opposite end, the first fluid port 304 connecting the first piston chamber 302 to the internal volume 202 of the pipe body 110 and the first fluid port 304 being configured to allow free passage of a pressurized fluid 20 from the fluid vessel 15 therebetween. In addition, the first piston 305 may be housed within the first piston chamber 302, the first piston 305 may include the first pin 306 and a first O-ring 307 (FIG. 3), the first pin 306 being moveable from a stowed state 308 to the extended state 309, the O-ring wrapped around an outer diameter of the first piston 305 and configured to prevent the pressurized fluid 20 from escaping through the first opening 303 and a first retraction means 310 (FIG. 3) configured to move the first pin 306 into the stowed state 308.

Similarly, the second piston housing 130 may be fixedly attached to the right side 204 of the pipe body 110, the second piston housing 130 may include the second piston chamber 402 (FIG. 4) including the second opening 403 at one end, and a second fluid port 404 (FIG. 4) at the opposite end, the second fluid port 404 connecting the second piston chamber 402 to the internal volume 202 of the pipe body 110 and the second fluid port 404 being configured to allow free passage of the pressurized fluid 20 from the fluid vessel 15 therebetween. Further still, the second piston 405 may be housed within the second piston chamber 402, the second piston 405 including the second pin 406 and a second O-ring 407 (FIG. 4); the second pin 406 being moveable from the stowed state 308 to the extended state 309, the O-ring wrapped around an outer diameter of the second piston 405 and configured to prevent the pressurized fluid 20 from escaping through the second opening 403 and a second retraction means 408 configured to move the second pin 406 into the stowed state 308.

FIG. 2B is a side view of the safety attachment of FIG. 2A, according to an embodiment of the present disclosure. Shown here is the first pin 306 and the second pin 406 in extended state 309. Here, the cam arms 10 of the camlock fitting 5 may be prevented from being lifted into the open-position such that the safety attachment 100 may not be removed from the camlock fitting 5. The first piston housing 120 may extend horizontally from the left side 203 of the pipe body 110, and similarly, the second piston housing 130 may extend horizontally from the right side 204 of the pipe body 110.

FIG. 3 is an internal view of the safety attachment of FIG. 1, according to an embodiment of the present disclosure. Shown here is an internal view of the first piston housing 120 and the internal volume 202 of the pipe body 110. As above, the pipe body 110 may include the internal volume 202 defined by a left side 203, a right side 204 opposite the left side 203, the first end 206, and the second end 207 opposite the first end 206, the first end 206 being configured to releasably attach to the fluid vessel 15, the second end 207 being configured to releasably attach to the camlock fitting 5. The first piston housing 120 may extend horizontally from the left side 203 of the pipe body 110, and similarly, the second piston housing 130 may extend horizontally from the right side 204 of the pipe body 110.

Further, the first piston housing 120 may be fixedly attached to the left side 203 of the pipe body 110, the first piston housing 120 including the first piston chamber 302 including the first opening 303 at one end, and the first fluid port 304 at the opposite end, the first fluid port 304 connecting the first piston chamber 302 to the internal volume 202 of the pipe body 110 and the first fluid port 304 being configured to allow free passage of the pressurized fluid 20 from the fluid vessel 15 therebetween. In addition, the first piston 305 may be housed within the first piston chamber 302, the first piston 305 may include the first pin 306 and a first O-ring 307, the first pin 306 being moveable from a stowed state 308 to an extended state 309; the O-ring wrapped around an outer diameter of the first piston 305 and configured to prevent the pressurized fluid 20 from escaping through the first opening 303 and the first retraction means 310 configured to move the first pin 306 into the stowed state 308.

In a preferred embodiment, the first retraction means 310 may be a first spring, and the second retraction means 408 may be a second spring. The first retraction means 310 may be located within the first piston chamber 302 adjacent the first opening 303, and the second retraction means 408 may be located within the second piston chamber 402 adjacent the second opening 403. The pressurized fluid 20 may be configured to exert a force on the first piston 305 and the second piston 405, respectively, to force the first pin 306 and the second pin 406 into the extended sate. In addition, the first spring 310 and the second spring 408 may be configured to exert a constant force on the first piston 305 and the second piston 405 respectively, to retain the first pin 306 and the second pin 406 in the stowed state 308. The force exerted by the pressurized fluid 20 on the first pin 306 and the second pin 406 may be stronger than the constant force exerted by the first spring 310 and the second spring 408.

Further, as illustrated, in the preferred embodiment the second end 207 of the safety attachment 100 may include the male thread; and the camlock fitting 5 may include the female thread configured to mate with the male thread of the second end 207.

FIG. 4A is a side view of the safety attachment according to an embodiment of the present disclosure. Shown here are the various components of the second piston housing 130. As above, the second piston housing 130 may be fixedly attached to the right side 204 of the pipe body 110, the second piston housing 130 may include a second piston chamber 402 including a second opening 403 at one end, and a second fluid port 404 at the opposite end, the second fluid port 404 connecting the second piston chamber 402 to the internal volume 202 of the pipe body 110 and the second fluid port 404 being configured to allow free passage of the pressurized fluid 20 from the fluid vessel 15 therebetween.

Further still, a second piston 405 may be housed within the second piston chamber 402, the second piston 405 including a second pin 406 and a second O-ring 407; the second pin 406 being moveable from the stowed state 308 to the extended state 309, the O-ring wrapped around an outer diameter of the second piston 405 and configured to prevent the pressurized fluid 20 from escaping through the second opening 403 and a second retraction means 408 configured to move the second pin 406 into the stowed state 308. The cam arms 10 may be located directly adjacent the first opening 303 and the second opening 403 respectively, such that when first pin 306 and the second pin 406 are in the extended state 309, they securely lock the cam arms 10 in the closed-position.

In a preferred embodiment, the first opening 303 may be partially covered with a first plate 315, and the second opening 403 may be partially covered with a second plate 316. Further, the first pin 306 and second pin 406 may be made from a steel alloy of high strength. The steel alloy may be of a strength configured to withstand the pressure exerted by the pressurized fluid, and pressure exerted by the first retraction means 310 (FIG. 3) and the second retraction means 408. Other materials may be used.

As above, in the preferred embodiment, the first retraction means 310 (FIG. 3) may be a first spring, and the second retraction means 408 may be a second spring. The first retraction means 310 may be located within the first piston chamber 302 adjacent the first opening 303, and the second retraction means 408 may be located within the second piston chamber 402 adjacent the second opening 403. The pressurized fluid 20 may be configured to exert a force on the first piston 305 and the second piston 405, respectively, to force the first pin 306 and the second pin 406 into the extended sate 309. In addition, the first spring 310 and the second spring 408 may be configured to exert a constant force on the first piston 305 and the second piston 405 respectively, to retain the first pin 306 and the second pin 406 in the stowed state 308. The force exerted by the pressurized fluid 20 on the first pin 306 and the second pin 406 may be stronger than the constant force exerted by the first spring 310 and the second spring 408.

FIG. 4B is a side view of the safety attachment of FIG. 1, according to an embodiment of the present disclosure. Illustrated here is the second pin 406 in the extended state 309. As shown, the first pin 306 (FIG. 3) and the second pin 406 may protrude at least one inch out of the first opening 303 and the second opening 403 respectively, when in the extended state 309. The cam arms 10 of the camlock fitting 5 may be located less than one inch away from the first opening 303 and the second opening 403 respectively such that when the first pin 306 and the second pin 406 are in the extended state 309, they securely lock the cam arms 10 in the closed-position. Further, as above, in the preferred embodiment, the first opening 303 may be partially covered with a first plate 315, and the second opening 403 may be partially covered with a second plate 316.

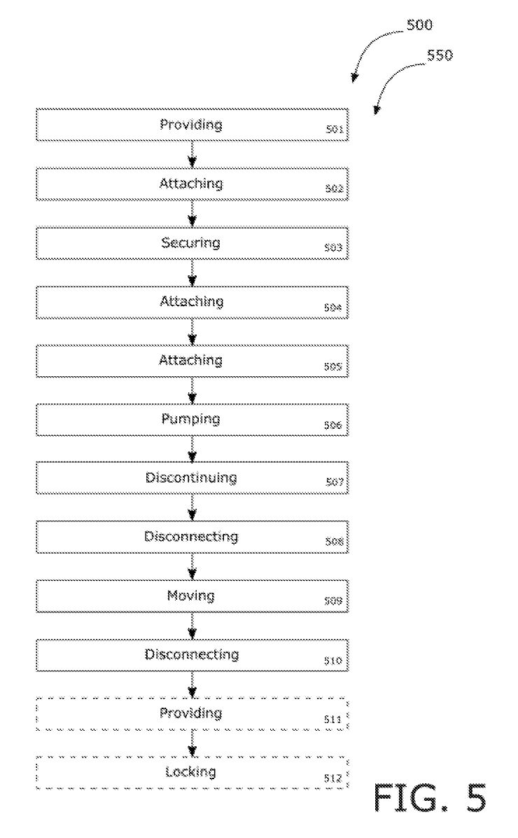

FIG. 5 is a flow diagram 550 illustrating a method for using 500 a safety attachment 100 for a camlock fitting, according to an embodiment of the present disclosure. In particular, the method for using 500 a safety attachment 100 for a camlock fitting may include one or more components or features of the safety attachment 100 as described above. As illustrated, the method for using a safety attachment for a camlock fitting 500 may include the steps of: step one 501, providing the safety attachment 100 (the safety attachment 100 including a pipe body 110 having an internal volume 202, a left side 203, a right side 204, a first end 206, a second end 207, a first piston housing 120 having a first piston chamber 302 including a first opening 303 and a first fluid port 304, a first piston 305 including a first pin 306, and a first retraction means 310, and a second piston housing 130 having a second piston chamber 402 including a second opening 403 and a second fluid port 404, a second piston 405 including a second pin 406, and a second retraction means 408); step two 502, attaching the second end 207 of the pipe body 110 to the camlock fitting 5; step three 503, securing the cam arms 10 of the camlock fitting 5 in the closed-position; step four 504 attaching the first end 206 of the pipe body 110 to a fluid vessel 15, the fluid vessel 15 configured to pump a pressurized fluid 20 through the pipe body 110 and the camlock fitting 5; step five 505, attaching a hose to the camlock fitting 5 at an opposite end to the attached pipe body 110; step six 506, pumping the pressurized fluid 20 through the pipe body 110 (the pressurized fluid 20 passing through the first fluid port 304 within the first piston chamber 302, and the second fluid port 404 within the second piston chamber 402 respectively, the pressurized fluid 20 exerting a force on the first piston 305 and the second piston 405 and causing the first pin 306 and the second pin 406 to move from a stowed state 308 to an extended state 309, the first and second pin 406 protruding at least one inch out of the first opening 303 and the second opening 403 in the extended state 309, the extended state 309 locking the cam arms 10 in the closed-position); step seven 507, discontinuing the flow of the pressurized fluid 20 from the fluid vessel 15 (the first retraction means 310 and the second retraction means 408 exerting a force on the first piston 305 and the second piston 405 and causing the first pin 306 and the second pin 406 to move from the extended state 309 to the stowed sate, the stowed state 308 releasing the cam arms 10 in the closed-position); step eight 508, disconnecting the first end 206 of the pipe body 110 from the fluid vessel 15; step nine 509, moving the cam arms 10 of the camlock fitting 5 from the closed-position to the open-position; and step ten 510, disconnecting the second end 207 of the pipe body 110 from the camlock fitting 5. Further steps may include: step eleven 511, providing the pipe body 110 further including a lock at a top side of the pipe body 110; and step twelve 512, locking the second end 207 of the pipe body 110 to the camlock fitting 5 to further secure the safety attachment 100 to the camlock fitting 5.

It should be noted that step eleven 511 and step twelve 512 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a safety attachment for a camlock fitting are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A safety attachment for a camlock fitting, the camlock fitting including two cam arms having an open-position and a closed-position, the safety attachment comprising:
a pipe body including an internal volume defined by a left side, a right side opposite the left side, a first end, and a second end opposite the first end, the first end being configured to releasably attach to a fluid vessel, the second end being configured to releasably attach to the camlock fitting;
a first piston housing fixedly attached to the left side of the pipe body, the first piston housing including:
a first piston chamber including a first opening at one end, and a first fluid port at the opposite end, the first fluid port connecting the first piston chamber to the internal volume of the pipe body and the first fluid port being configured to allow free passage of a pressurized fluid from the fluid vessel therebetween;
a first piston housed within the first piston chamber, the first piston including a first pin and a first O-ring, the first pin being moveable from a stowed state to an extended state, the O-ring wrapped around an outer diameter of the first piston and configured to prevent the pressurized fluid from escaping through the first opening; and
a first retraction means configured to move the first pin into the stowed state; and
a second piston housing fixedly attached to the right side of the pipe body, the second piston housing including:
a second piston chamber including a second opening at one end, and a second fluid port at the opposite end, the second fluid port connecting the second piston chamber to the internal volume of the pipe body and the second fluid port being configured to allow free passage of the pressurized fluid from the fluid vessel therebetween;
a second piston housed within the second piston chamber, the second piston including a second pin and a second O-ring, the second pin being moveable from the stowed state to the extended state, the O-ring wrapped around an outer diameter of the second piston and configured to prevent the pressurized fluid from escaping through the second opening; and
a second retraction means configured to move the second pin into the stowed state; and
wherein the cam arms are directly adjacent the first opening and the second opening respectively, such that when first pin and the second pin are in the extended state, they securely lock the cam arms in the closed-position.

2. The safety attachment of claim 1, wherein the first retraction means is a first spring, and the second retraction means is a second spring.

3. The safety attachment of claim 2, wherein the first retraction means is located within the first piston chamber adjacent the first opening, and the second retraction means is located within the second piston chamber adjacent the second opening.

4. The safety attachment of claim 1, wherein the pressurized fluid is configured to exert a force on the first piston and the second piston, respectively, to force the first pin and the second pin into the extended sate.

5. The safety attachment of claim 4, wherein the first spring and the second spring are configured to exert a constant force on the first piston and the second piston respectively, to retain the first pin and the second pin in the stowed state.

6. The safety attachment of claim 5, wherein the force exerted by the pressurized fluid on the first and the second pin is stronger than the constant force exerted by the first spring and the second spring.

7. The safety attachment of claim 1, wherein the second end of the safety attachment includes a male thread.

8. The safety attachment of claim 7, wherein the camlock fitting includes a female thread configured to mate with the male thread of the second end.

9. The safety attachment of claim 1, wherein the first opening is partially covered with a first plate, and the second opening is partially covered with a second plate.

10. The safety attachment of claim 1, wherein the first piston housing extends horizontally from the left side of the pipe body.

11. The safety attachment of claim 12, wherein the second piston housing extends horizontally from the right side of the pipe body.

12. The safety attachment of claim 1, wherein the pipe body is substantially equal in diameter to the cam lock fitting.

13. The safety attachment of claim 13, wherein the safety attachment further includes a lock and a key for securely locking the attachment to the cam lock fitting.

14. The safety attachment of claim 1, wherein the first pin and second pin are made from a steel alloy of high strength.

15. The safety attachment of claim 14, wherein the first pin and second pin protrude at least one inch out of the first opening and the second opening respectively, when in the extended state.

16. The safety attachment of claim 15, wherein the cam arms of the camlock fitting are located less than one inch away from the first opening and the second opening respectively.

17. A safety attachment for a camlock fitting, the camlock fitting including two cam arms having an open-position and a closed-position, the safety attachment comprising:
a pipe body including an internal volume defined by a left side, a right side opposite the left side, a first end, and a second end opposite the first end, the first end being configured to releasably attach to a fluid vessel, the second end being configured to releasably attach to the camlock fitting;
a first piston housing fixedly attached to the left side of the pipe body, the first piston housing including:
a first piston chamber including a first opening at one end, and a first fluid port at the opposite end, the first fluid port connecting the first piston chamber to the internal volume of the pipe body and the first fluid port being configured to allow free passage of a pressurized fluid from the fluid vessel therebetween;
a first piston housed within the first piston chamber, the first piston including a first pin and a first O-ring, the first pin being moveable from a stowed state to an extended state, the O-ring wrapped around an outer diameter of the first piston and configured to prevent the pressurized fluid from escaping through the first opening; and
a first retraction means configured to move the first pin into the stowed state; and
a second piston housing fixedly attached to the right side of the pipe body, the second piston housing including:
a second piston chamber including a second opening at one end, and a second fluid port at the opposite end, the second fluid port connecting the second piston chamber to the internal volume of the pipe body and the second fluid port being configured to allow free passage of the pressurized fluid from the fluid vessel therebetween;
a second piston housed within the second piston chamber, the second piston including a second pin and a second O-ring, the second pin being moveable from the stowed state to the extended state, the O-ring wrapped around an outer diameter of the second piston and configured to prevent the pressurized fluid from escaping through the second opening; and
a second retraction means configured to move the second pin into the stowed state; and
wherein the cam arms are directly adjacent the first opening and the second opening respectively, such that when first pin and the second pin are in the extended state, they securely lock the cam arms in the closed-position; and
wherein the first retraction means is a first spring, and the second retraction means is a second spring;
wherein the first retraction means is located within the first piston chamber adjacent the first opening, and the second retraction means is located within the second piston chamber adjacent the second opening;
wherein the pressurized fluid is configured to exert a force on the first piston and the second piston, respectively, to force the first pin and the second pin into the extended sate;
wherein the first spring and the second spring are configured to exert a constant force on the first piston and the second piston respectively, to retain the first pin and the second pin in the stowed state;
wherein the force exerted by the pressurized fluid on the first and the second pin is stronger than the constant force exerted by the first spring and the second spring;
wherein the second end of the safety attachment includes a male thread;
wherein the camlock fitting includes a female thread configured to mate with the male thread of the second end;
wherein the first opening is partially covered with a first plate, and the second opening is partially covered with a second plate;
wherein the first piston housing extends horizontally from the left side of the pipe body;
wherein the second housing extends horizontally from the right side of the pipe body;
wherein the pipe body is substantially equal in diameter to the cam lock fitting;
wherein the safety attachment further includes a lock and a key for securely locking the attachment to the cam lock fitting;
wherein the first pin and second pin are made from a steel alloy of high strength;
wherein the first pin and second pin protrude at least one inch out of the first opening and the second opening respectively, when in the extended state; and
wherein the cam arms of the camlock fitting are located less than one inch away from the first opening and the second opening respectively.

18. The safety attachment of claim 17, further comprising set of instructions; and
wherein the safety attachment is arranged as a kit.

19. A method for using a safety attachment for a camlock fitting, the camlock fitting including two cam arms having an open-position and a closed-position, the method comprising the steps of:
providing the safety attachment, the safety attachment including a pipe body having an internal volume, a left side, a right side, a first end, a second end, a first piston housing having a first piston chamber including a first opening and a first fluid port, a first piston including a first pin, and a first retraction means, and a second piston housing having a second piston chamber including a second opening and a second fluid port, a second piston including a second pin, and a second retraction means;
attaching the second end of the pipe body to the camlock fitting;
securing the cam arms of the camlock fitting in the closed-position;
attaching the first end of the pipe body to a fluid vessel, the fluid vessel configured to pump a pressurized fluid through the pipe body and the camlock fitting;
attaching a hose to the camlock fitting at an opposite end to the attached pipe body;
pumping the pressurized fluid through the pipe body, the pressurized fluid passing through the first fluid port within the first piston chamber, and the second fluid port within the second piston chamber respectively, the pressurized fluid exerting a force on the first piston and the second piston and causing the first pin and the second pin to move from a stowed state to an extended state, the first and second pin protruding at least one inch out of the first opening and the second opening in the extended state, the extended state locking the cam arms in the closed-position;
discontinuing the flow of the pressurized fluid from the fluid vessel, the first retraction means and the second retraction means exerting a force on the first piston and the second piston and causing the first pin and the second pin to move from the extended state to the stowed sate, the stowed state releasing the cam arms in the closed-position;
disconnecting the first end of the pipe body from the fluid vessel;
moving the cam arms of the camlock fitting from the closed-position to the open-position; and
disconnecting the second end of the pipe body from the camlock fitting.

20. The method of claim 19, further comprising the steps of:
providing the pipe body further including a lock at a top side of the pipe body;
locking the second end of the pipe body to the camlock fitting to further secure the safety attachment to the camlock fitting.
